(19) United States
(12) Patent Application Publication
(10) Pub. No.: US 2013/0299633 A1
(43) Pub. Date: Nov. 14, 2013

(54) LANDING GEAR FOR AN AIRCRAFT

(71) Applicants: Malcolm Oliver Tierney, Oxfordshire (GB); Craig Scarisbrick, Northwich (GB); Miles Tucker, Cheltenham (GB); Robert John Neal, Swindon (GB)

(72) Inventors: Malcolm Oliver Tierney, Oxfordshire (GB); Craig Scarisbrick, Northwich (GB); Miles Tucker, Cheltenham (GB); Robert John Neal, Swindon (GB)

(73) Assignee: GE AVIATION SYSTEMS LIMITED, Cheltenham (GB)

(21) Appl. No.: 13/609,846

(22) Filed: Sep. 11, 2012

(30) Foreign Application Priority Data
May 10, 2012 (GB) 12081550

(51) Int. Cl. B64C 25/10; B64C 25/26

(52) U.S. Cl. 244/102 SL; 244/102 R

(57) ABSTRACT

A landing gear assembly for an aircraft includes a leg having a first rotational mount for rotatably mounting the leg to the aircraft for rotating the leg between retracted and extended positions, a wheel mount provided on the leg, a drag stay having an upper link rotatably mounted to a lower link, and an actuator to move the leg between the retracted and extended positions. The landing gear may be included on a variety of aircraft.

### CROSS-REFERENCE TO RELATED APPLICATIONS

This application claims priority under 35 U.S.C. §119 to British Patent Application No. 12081550, filed May 10, 2012, the disclosure of which is incorporated herein by reference.

### BACKGROUND OF THE INVENTION

Contemporary aircraft may be equipped with retractable landing gear, which typically can be raised following take-off and stowed in a closable compartment on the underside of the aircraft. Landing gear may often be provided under either wing and under the nose of the aircraft. When the landing gear has been raised, the landing gear may be locked in place with uplocks, to prevent unintended extension of the landing gear, until such time as the landing gear is to be used again. Further, safety measures may be included to ensure that when the landing gear is extended it does not accidentally retract.

### BRIEF DESCRIPTION OF THE INVENTION

In one embodiment, a landing gear assembly for an aircraft includes a leg having a first rotational mount proximate a first end of the leg for rotatably mounting the leg to the aircraft for rotating the leg between retracted and extended positions, a wheel mount provided on the leg proximate to a second end of the leg, a drag stay having an upper link rotatably mounted to a lower link, the upper link having a second rotational mount for rotatably mounting the upper link to the aircraft, and the lower link having a third rotational mount for rotatably mounting the lower link to the leg, and an actuator to move the leg between the retracted and extended positions.

In another embodiment an aircraft includes a fuselage, a pair of wings mounted to the fuselage, and landing gear operably coupled to at least one of the fuselage and one of the pair of wings and includes a leg having a first rotational mount proximate a first end of the leg for rotatably mounting the leg to the at least one of the fuselage and one of the pair of wings for rotating the leg between retracted and extended positions, a wheel mount provided on the leg proximate to a second end of the leg, a drag stay having an upper link rotatably mounted to a lower link, the upper link having a second rotational mount for rotatably mounting the upper link to the at least one of the fuselage and one of the pair of wings, and the lower link having a third rotational mount for rotatably mounting the lower link to the leg, and an actuator coupled between the leg and the drag stay to move the leg between the retracted and extended positions.

In yet another embodiment, an aircraft includes a fuselage and landing gear operably coupled to the fuselage and includes a leg having a first rotational mount proximate a first end of the leg for rotatably mounting the leg to the at least one of the fuselage for rotating the leg between retracted and extended positions, a wheel mount provided on the leg proximate to a second end of the leg, a drag stay having an upper link rotatably mounted to a lower link, the upper link having a second rotational mount for rotatably mounting the upper link to the at least one of the fuselage, and the lower link having a third rotational mount for rotatably mounting the lower link to the leg, and an actuator coupled between the leg and the drag stay to move the leg between the retracted and extended positions.

### BRIEF DESCRIPTION OF THE DRAWINGS

In the drawings:

FIG. 1 is a perspective view of a portion of a landing gear assembly known in the prior art.

FIG. 2 is a schematic illustration of a landing gear assembly according to an embodiment of the invention.

FIG. 3 is a side view of a portion of the landing gear assembly of FIG. 2.

FIG. 4 is a side view of the portion of the landing gear assembly of FIG. 3 showing the results of rotation of an actuator.

FIG. 5 is a side view of the portion of the landing gear assembly of FIG. 2 showing the results of rotation of an actuator.

FIG. 6 is a side view of the portion of the landing gear assembly of FIG. 3 showing the results of further rotation of the actuator.

### DESCRIPTION OF EMBODIMENTS OF THE INVENTION

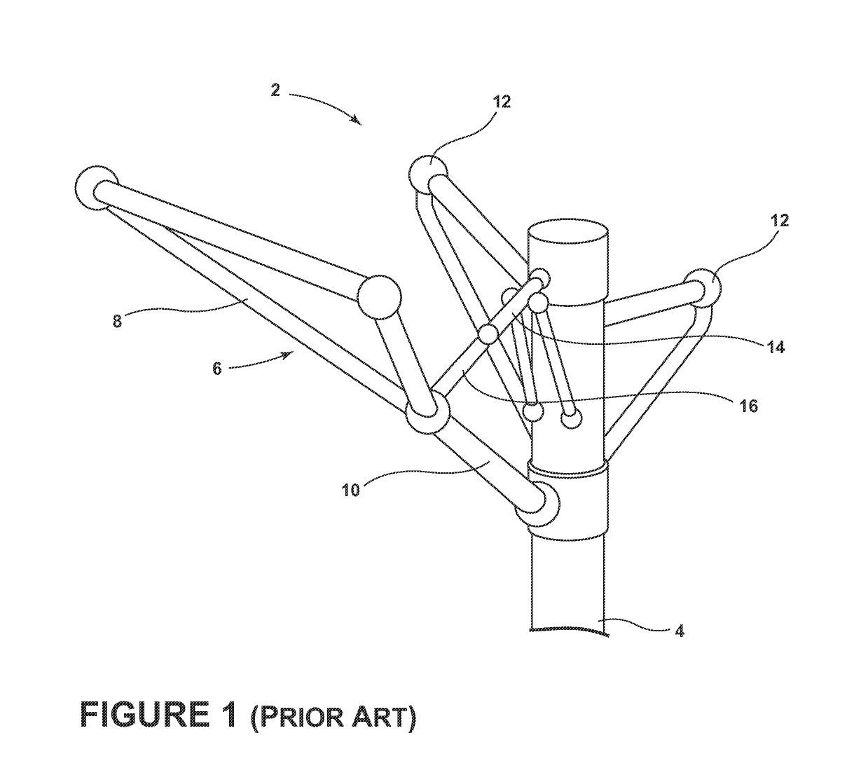

FIG. 1 illustrates a typical prior art landing gear assembly having a landing gear assembly 2 for an aircraft including a leg 4 on which a wheel may be mounted, a drag stay 6 having an upper link 8 rotatably mounted to a lower link 10. In conventional aircraft, retraction and extension of the landing gear assembly 2 is usually accomplished by the use of a linear actuator (not shown), mounted to a hard point on the aircraft structure and attached to the landing gear leg 4. In such landing gear assemblies 2, when the landing gear leg 4 is fully extended, the upper link 8 and lower link 10 of the drag stay 6 are aligned, locking the leg 4 in position. As the drag stay 6 folds, the landing gear leg 4 rotates about pintle pins 12 until it reaches the fully retracted position. In the extended position, the drag stay 6 is held in a locked position by use of a pair of lock stay links 14 and 16, which by going over-center lock themselves in position, thus locking the drag stay 6 in position. Such a conventional landing gear assembly 2 makes use of a separate unlock actuator (not shown) to unlock these lock stay links 14 and 16. In the retracted position, a separate up-lock actuator (not shown) is usually used to lock the landing gear assembly 2 in position. This up-lock must be released by an actuator in order to allow the landing gear assembly 2 to extend.

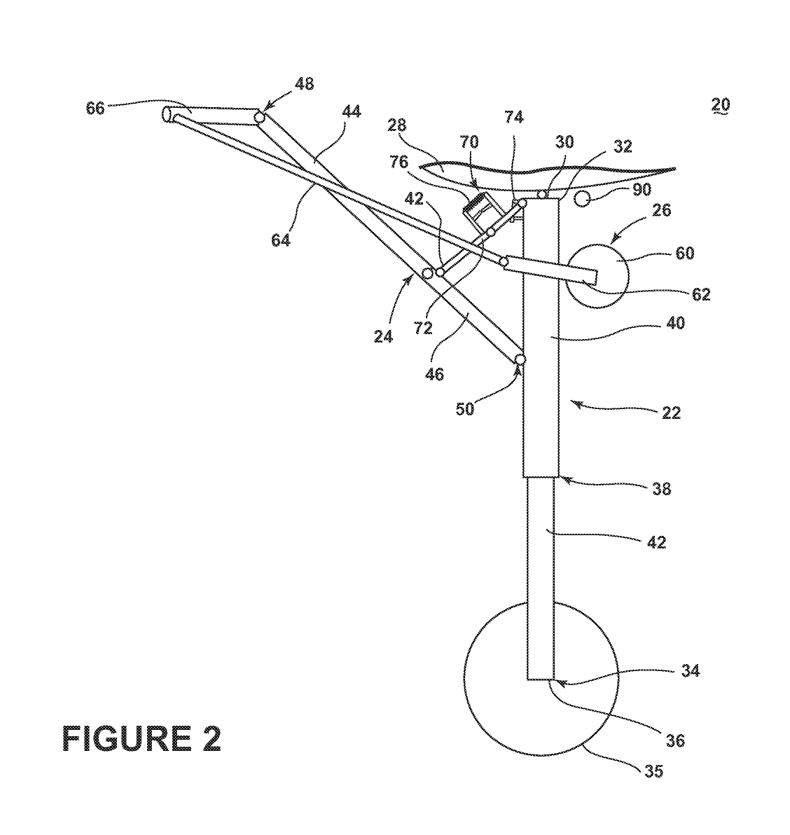

Embodiments of the invention eliminate the need for the down-lock and up-lock actuators and eliminate the need for a separate aircraft structural hard point for mounting a linear actuator. Referring to FIG. 2, a landing gear assembly 20 according to an embodiment of the invention is illustrated and includes among other things a leg 22, a drag stay 24, and an actuator 26. The leg 22 has a first rotational mount 30 proximate a first end 32 of the leg 22 for rotatably mounting the leg 22 to the aircraft 28. The leg 22 may be mounted to the fuselage or the wings of the aircraft. The first rotational mount 30 may mount the leg 22 such that it may be rotated between retracted and extended positions. In the retracted position the leg 22 may be accommodated within a landing gear bay within the fuselage or wings of the aircraft.

A wheel mount 34 may be included on the leg 22 proximate to a second end 36 of the leg 22 and a wheel 35 may be mounted thereon. As illustrated, a strut 38 having a casing 40 and a piston 42 may form the leg 22. The piston 42 may be received in the casing 40 for relative reciprocal movement therewith. The wheel mount 34 has been illustrated as being provided on the piston 42.

An upper link 44 rotatably mounted to a lower link 46 may form the drag stay 24. A second rotational mount 48 may be included in the upper link 44 for rotatably mounting the upper link 44 to the aircraft. A third rotational mount 50 may be included in the lower link 46 for rotatably mounting the lower link 46 to the leg 22.

The actuator 26 may be a single rotary actuator 26, which may be mounted rigidly to the leg 22 structure. The rotary actuator 26 may be operably coupled between the leg 22 and the drag stay 24 such that it may move the leg 22 between retracted and extended positions. The rotary actuator 26 may include a motor 60, a drive arm 62 rotated by the motor 60, and a connecting rod 64. The connecting rod 64 may be rotationally coupled to the drive arm 62. As illustrated, the motor 60 may be coupled to the leg 22 and the connecting rod 64 is coupled to the upper link 44. More specifically, the motor 60 is illustrated as being coupled to the casing 40 and the connecting rod 64 is coupled to an extension 66 of the upper link 44 that extends beyond the second rotational mount 48. Alternatively, it is contemplated that the motor 60 may be coupled to the upper link 44 and the connecting rod may be coupled to the leg 22. The motor 60 may be any suitable electric motor. The rotary actuator 26 may employs a high reduction ratio gearing to provide the torque necessary to perform the retraction and extension of the landing gear assembly 20. The rotary actuator 26 may have no internal hard stops, allowing for 360° operation.

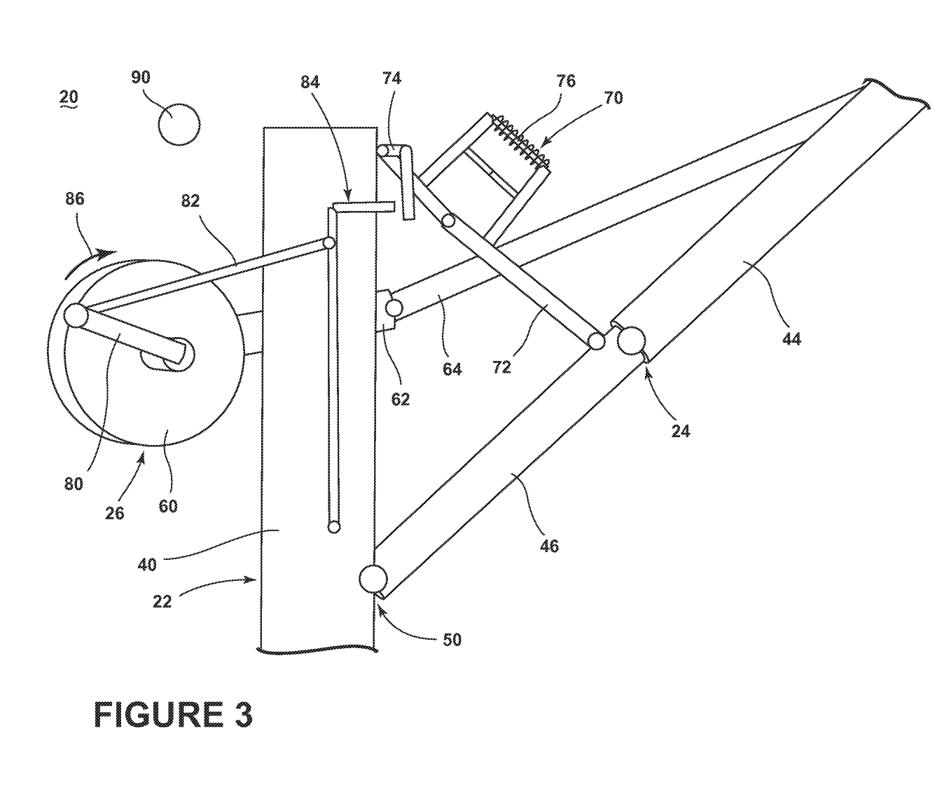

A down-lock mechanism 70 may be included in the landing gear assembly 20 and is illustrated more clearly in FIG. 3 as being operably coupled between the leg 22 and the drag stay 24. The down-lock mechanism 70 may prevent raising of the landing gear assembly 20 from the extended position. More specifically the down-lock mechanism 70 prevents relative rotation of the leg 22 and drag stay 24 when the landing gear assembly 20 is in the extended position. The down-lock mechanism 70 is illustrated as including a first link 72 rotationally coupled to a second link 74 and a spring unit or a spring and damper unit 76 as more clearly seen in FIG. 3. The first link 72 may be rotationally coupled to the drag stay 24 and the second link 74 may be rotationally coupled to the leg 22. Although such rotational couplings are not illustrated in the schematic illustrations it will be understood that the rotational coupling may be achieved in any suitable manner. The first and second links 72 and 74 may be rotatable to an over-center position when the leg 22 is extended to lock the leg 22 in the extended position. FIG. 3 also more clearly shows that the rotary actuator 26 includes a second drive arm 80 and a second connecting rod 82, which may operably couple to a down-lock release mechanism 84 and allow the rotary actuator 26 to operably couple to the down-lock mechanism 70. More specifically, the connecting rod 82 is of a fixed length and may push the down-lock release mechanism 84, which in turn may make momentary contact with the release lever on the second link 74 to release the down-lock mechanism 70. The rotary actuator 26 may unlock the down-lock mechanism 70 upon actuation of the rotary actuator 26 to move the leg 22 from the extended position to the retracted position.

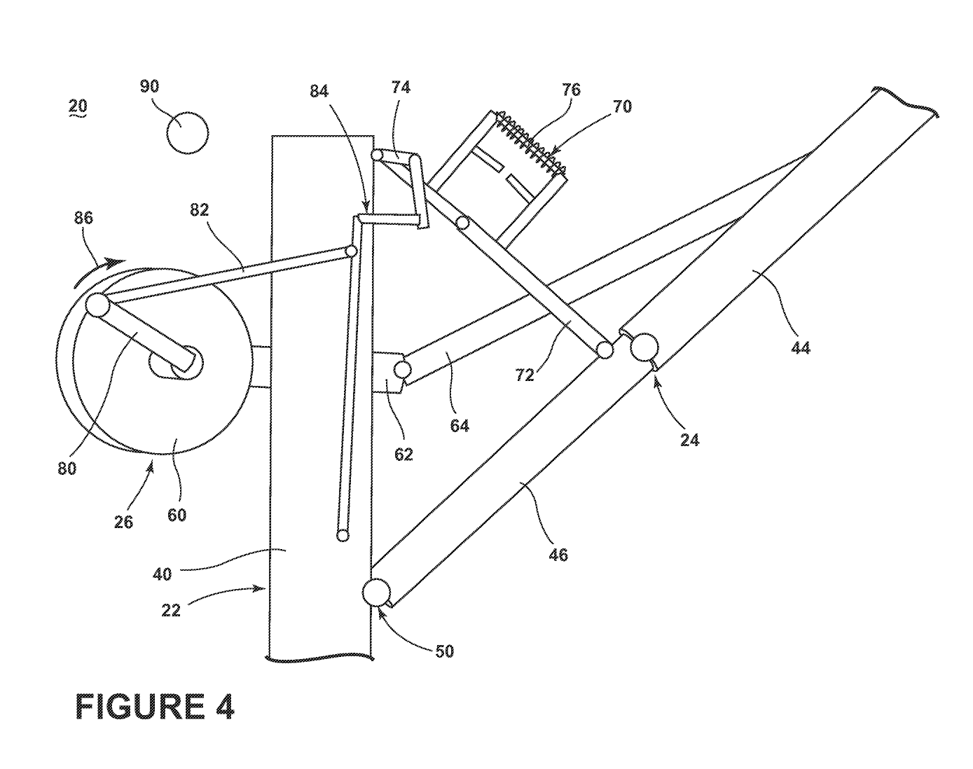

Assuming the landing gear assembly 20 is initially in the fully extended position as in FIG. 3, during operation, the rotary actuator 26 is driven to rotate in the direction of the arrow 86. This causes the initial rotation of the second drive arm 80 and causes the second connecting rod 82 to move slightly which is in pivotal contact with the down-lock release mechanism 84, which in turn causes the down-lock release mechanism 84 to force the down-lock mechanism 70 to unlock. More specifically, movement of the down-lock release mechanism 84 results in increasing the load in the spring and damper unit 76 and causes the down-lock mechanism 70 to unlock. The movement of the down-lock release mechanism 84 acts to extend the tension spring during the releasing and retraction process and the load in the spring and damper unit 76 begins to reduce slightly when approaching the up-lock position. Thus, the second drive arm 80 and second connecting rod 82 are configured to move the first and second links 72 and 74 out of the over-center position as shown in FIG. 4. The down-lock release mechanism 84 will return to its original position or near its original position when the landing gear assembly 20 is fully up-locked, and again when the landing gear assembly 20 is returned to a down-locked position. In this manner, the rotary actuator 26 may be operably coupled to the down-lock mechanism 70 such that the rotary actuator 26 may unlock the down-lock mechanism 70 upon actuation of the rotary actuator 26 to move the leg 22 from the extended position to the retracted position.

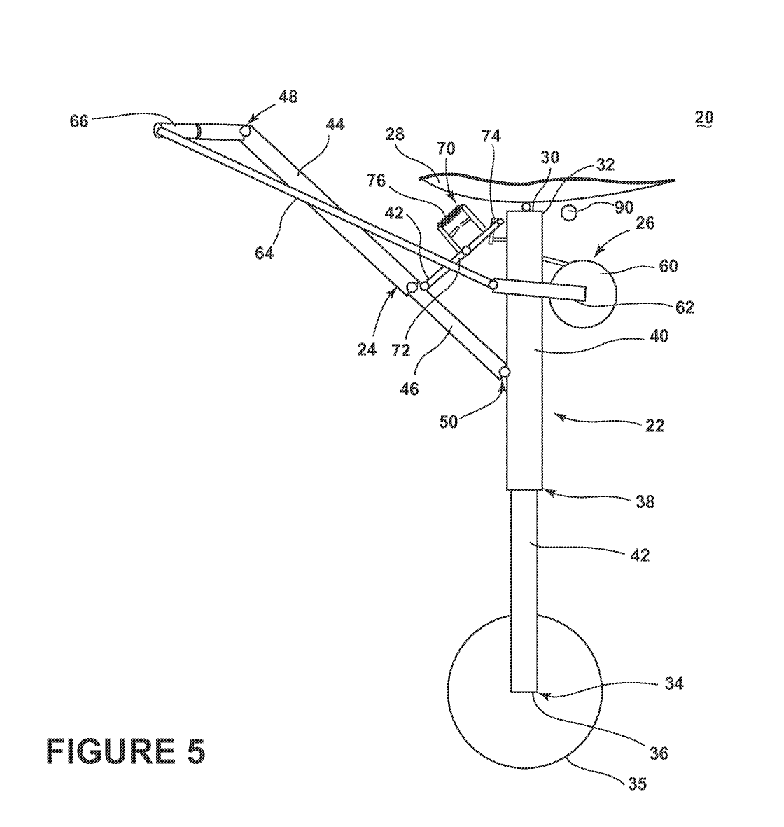

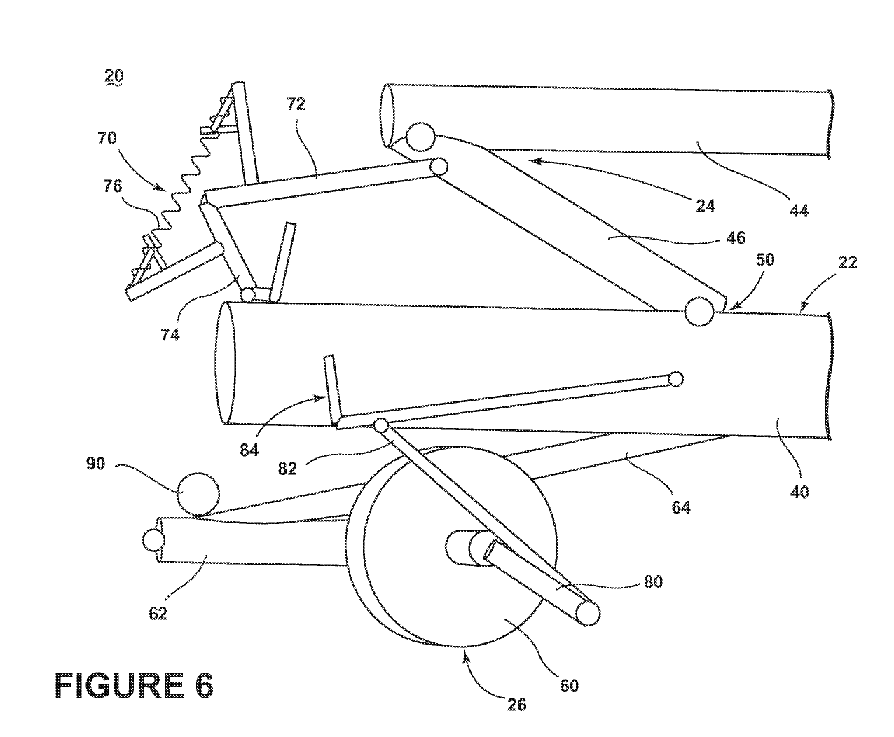

As shown in FIG. 5, the initial rotation of the rotary actuator 26 also initially causes the drive arm 62 to be rotated such that the connecting rod 64 extends slightly, while the down lock links are still locked. Further rotation of drive arm 62 releases the down-lock mechanism 70, allowing the connecting rod 64 to pull and cause rotation of the extension 66. Without such motion of the connecting rod 64 being taken up by this rotation, the landing gear assembly 20 would lock up and not be able to move. Continued rotation of the rotary actuator 26 may cause the drive arm 62 to be rotated such that the connecting rod 64 extends and pulls on the extension 66 of the upper link 44 causing it to rotate and fold the drag stay 24 and retract the landing gear assembly 20. The rotary actuator 26 will continue rotating until the retracted position is achieved when the drive arm 62 and connecting rod rotate all the way around in a counter clockwise movement until they contact a hard stop position, shown schematically as 90 in FIG. 6. The hard stop 90 may be any suitable stop mounted to the landing gear assembly 20. Up-locking of the landing gear assembly 20 is achieved by the drive arm 62 and connecting rod 64 coming up against the hard stop 90. The landing gear assembly 20 will remain in this condition following the removal of power from the rotary actuator 26. This will leave the drive arm 62 and connecting rod 64 subjected to gravity loads from the leg 22, which will tend to push the mechanism further into the locked position, i.e. push the drive arm 62 onto the hard stop 90 and gravity loads will not try to unlock the mechanism. Thus, the landing gear assembly 20 is held in the up-lock position by the weight of the landing gear assembly 20 and the over-centered linkage arrangement, and further internal gearing resistance to rotation.

To lower the landing gear assembly 20, the rotary actuator 26 is reversed, which may initially raise the landing gear assembly 20 slightly before allowing the landing gear assembly 20 to extend to the down-locked condition. The landing gear assembly 20 is extended until the down-lock mechanism is locked. The landing gear assembly 20 will remain in this condition following removal of power from the rotary actuator 26 due to the down-lock mechanism 70. In this manner, the rotary actuator 26 operates both the down lock release mechanism 84 and the drag stay actuation mechanism.

The above described embodiments provide for a variety of benefits including that the single rotary actuator provides the motion for the mechanisms required for extension and retraction and the up-locking and down-locking of the aircraft landing gear assembly. The above embodiments provide all the necessary functions of a landing gear extension/retraction system with only one actuator and a simplified control system compared to typical systems that have at least two actuators and a complex control system. Further, the connections from the actuator are to points on the landing gear leg and drag-stay and require no additional mounting features on the aircraft structure, which improves maintenance and any required replacement of parts. Further, the spring and damper unit may act to accommodate load and displacement and absorb any disturbances caused by aircraft vibrations which may cause the mechanism to bounce out of lock. This may be achieved either through the material properties of the spring and damper unit or by incorporation of a self-contained mechanical device. The actual landing gear leg may also permit a small degree of bouncing movement in the retracted position, to the limits allowed by the travel of the spring and damper unit. Sufficient clearance may be necessary within the landing gear bay to accommodate this movement of the landing gear leg. While the above embodiments have been described with respect to an aircraft that may include wings it is contemplated that the aircraft may include a helicopter or other aircraft not having fixed wings, in which case the landing gear would be attached to the fuselage.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A landing gear assembly for an aircraft comprising:
a leg having a first rotational mount proximate a first end of the leg for rotatably mounting the leg to the aircraft for rotating the leg between retracted and extended positions;
a wheel mount provided on the leg proximate to a second end of the leg;
a drag stay having an upper link rotatably mounted to a lower link, the upper link having a second rotational mount for rotatably mounting the upper link to the aircraft, and the lower link having a third rotational mount for rotatably mounting the lower link to the leg; and
an actuator coupled between the leg and the drag stay to move the leg between the retracted and extended positions.

2. The landing gear assembly of claim 1 wherein the actuator comprises a rotary actuator.

3. The landing gear assembly of claim 2 wherein the rotary actuator comprises a motor, a drive arm rotated by the motor, and a connecting rod, with the motor coupled to one of the leg and upper link and the connecting rod coupled to the other of the leg and upper link.

4. The landing gear assembly of claim 3 wherein the motor is coupled to the leg and the connecting rod is coupled to the upper link.

5. The landing gear assembly of claim 4 wherein the upper link further comprises an extension extending beyond the second rotational mount and the connecting rod is coupled to the extension.

6. The landing gear assembly of claim 5 wherein the connecting rod is rotationally coupled to the drive arm.

7. The landing gear assembly of claim 6, further comprising a down-lock having a first link rotationally coupled to a second link, with the first link rotationally coupled to the drag stay and the second link rotationally coupled to the leg, and the first and second links are rotatable to an over-center position when the leg is extended to lock the leg in the extended position.

8. The landing gear assembly of claim 7 wherein the rotary actuator further comprises a second drive arm configured to move the first and second links out of the over-center position upon movement of the landing gear from the extended position to the retracted position.

9. The landing gear assembly of claim 8 wherein the leg comprises a strut having a casing, a piston received in the casing for relative reciprocal movement, and the motor is coupled to the casing and the wheel mount is provided on the piston.

10. The landing gear assembly of claim 1, further comprising a down-lock preventing raising of the landing gear from the extended position.

11. The landing gear assembly of claim 10 wherein the down-lock is operably coupled between the leg and the drag stay to prevent relative rotation of the leg and drag stay when the landing gear is in the extended position.

12. The landing gear assembly of claim 11 wherein the actuator is operably coupled to the down-lock and unlocks the down-lock upon actuation of the actuator to move the leg from the extended to the retracted position.

13. An aircraft comprising:
a fuselage;
a pair of wings mounted to the fuselage; and
landing gear operably coupled to at least one of the fuselage and one of the pair of wings and comprising:
a leg having a first rotational mount proximate a first end of the leg for rotatably mounting the leg to the at least one of the fuselage and one of the pair of wings for rotating the leg between retracted and extended positions;
a wheel mount provided on the leg proximate to a second end of the leg;
a drag stay having an upper link rotatably mounted to a lower link, the upper link having a second rotational mount for rotatably mounting the upper link to the at least one of the fuselage and one of the pair of wings, and the lower link having a third rotational mount for rotatably mounting the lower link to the leg; and
an actuator coupled between the leg and the drag stay to move the leg between the retracted and extended positions.

14. The aircraft of claim 13 wherein the actuator comprises a rotary actuator.

15. The aircraft of claim 14 wherein the rotary actuator comprises a motor, a drive arm rotated by the motor, and a connecting rod, with the motor coupled to one of the leg and upper link and the connecting rod coupled to the other of the leg and upper link.

16. The aircraft of claim 15 wherein the upper link further comprises an extension extending beyond the second rotational mount and the connecting rod is coupled to the extension.

17. The aircraft of claim 16, further comprising a down-lock having a first link rotationally coupled to a second link, with the first link rotationally coupled to the drag stay and the second link rotationally coupled to the leg, and the first and second links are rotatable to an over-center position when the leg is extended to lock the leg in the extended position.

18. The aircraft of claim 17 wherein the rotary actuator further comprises a second drive arm configured to move the first and second links out of the over-center position upon movement of the landing gear from the extended position to the retracted position.

19. The aircraft of claim 13, wherein the landing gear further comprises a lock preventing raising of the landing gear from the extended position.

20. An aircraft comprising:
a fuselage; and
landing gear operably coupled to the fuselage and comprising:
a leg having a first rotational mount proximate a first end of the leg for rotatably mounting the leg to the at least one of the fuselage for rotating the leg between retracted and extended positions;
a wheel mount provided on the leg proximate to a second end of the leg;
a drag stay having an upper link rotatably mounted to a lower link, the upper link having a second rotational mount for rotatably mounting the upper link to the at least one of the fuselage, and the lower link having a third rotational mount for rotatably mounting the lower link to the leg; and
an actuator coupled between the leg and the drag stay to move the leg between the retracted and extended positions.
